(19) United States
(12) Patent Application Publication
(10) Pub. No.: US 2021/0270291 A1
(43) Pub. Date: Sep. 2, 2021

(54) BLOWER

(71) Applicant: Koki Holdings Co., Ltd., Tokyo (JP)

(72) Inventor: Naoto ICHIHASHI, Ibaraki (JP)

(73) Assignee: Koki Holdings Co., Ltd., Tokyo (JP)

(21) Appl. No.: 16/326,367

(22) PCT Filed: Aug. 25, 2017
(86) PCT No.: PCT/JP2017/030547

§ 371 Date: Feb. 18, 2019

(30) Foreign Application Priority Data
Sep. 30, 2016 (JP) 2016-192970

(51) Int. Cl. F04D 29/70; F04D 29/42; F04D 17/10; F04D 25/08

(52) U.S. Cl. CPC F04D 29/703; F04D 29/4226; F04D 25/086; F04D 17/10; F04D 29/4213

(57) ABSTRACT

In this portable blower, which has a fan guard (40) attached to the outside of a suction opening (30) formed in a side surface of a volute chamber (24) accommodating a blower fan (20), a concave portion that is recessed from the outside toward the suction opening (30) and is arranged substantially concentrically with the blower fan (20) in the axial direction is formed in the fan guard (40), multiple first air holes (45-48) are formed on the inside of the concave portion, and multiple second air holes (42) are formed on the outside of the concave portion. Even if an obstructing object (X) adheres to the fan guard (40) air flows as in (BA3) and (BA4), and negative pressure in the indented area is dispersed, so the state of clinging can easily be eliminated.

### TECHNICAL FIELD

The present invention relates to a structure of a handheld blower (blowing operation machine) and particularly to an improvement in a structure of a guard provided in a suction opening of a blower fan.

### BACKGROUND ART

Portable blowers that use engines as drive sources are commercially available. As one of such blowers, a fan in a device is rotated by driving an engine, and air suctioned from a suction opening in a housing is caused to be ejected from a discharge port in the housing, as disclosed in Patent Literature 1, for example. The blower is adapted such that a pipe, a nozzle, or the like is attached to the discharge port of the blower fan, and the nozzle is directed to a target to be blown, such as fallen leaves or mown grass to blow and gather the target by wind pressure while an operator is holding the blower in a state in which the operator is gripping a handle portion.

### CITATION LIST

### Patent Literature

### [Patent Literature 1]

Japanese Unexamined Patent Application Publication No. 2009-264297

### SUMMARY OF INVENTION

### Technical Problem

The handheld blowers in the related art have problems such as a reduction in blowing performance, increases in vibration, noise, and fuel consumption caused by excessive rotation of the engine, and degradation of handle operability due to suctioning force, due to clinging of operator's clothing to the suction opening of the blower fan.

The present invention was made in view of the above background, and an object thereof is to provide a blower that is capable of preventing a reduction in blowing performance even when clothing or the like clings to a suction opening of a blower fan and that facilitates releasing of the clinging state. Another object of the present invention is to provide a blower that realizes an effect of suppressing a phenomenon of suctioning into the suction opening of the blower fan by improving the shape of a fan guard.

### Solution to Problem

Representative features of the invention disclosed in the present application will be described as follows. According to a feature of the present invention, there is provided a portable blower including: a drive source that causes a blower fan to rotate; a housing that accommodates the drive source and includes a handle portion formed thereon; a volute chamber that accommodates the blower fan; a suction opening that is formed in a wall surface of the volute chamber; and a fan guard that is attached to the outside of the suction opening, in which a concave portion that is recessed from the outside toward the side of the suction opening and is arranged substantially concentrically with an axial direction of the blower fan is formed in the fan guard, multiple first air holes are formed inside the concave portion, and multiple second air holes are formed outside the concave portion. The first air holes and the second air holes in the fan guard enable negative pressure generated by the blower fan to be dispersed.

According to another feature of the present invention, a total area of the first air holes in a first opening region that is formed inside the concave portion of the fan guard is smaller than a total area of the second air holes in a second opening region that is formed outside the concave portion. In addition, the first air holes in the first opening region are formed to include openings that are obliquely formed relative to the axial direction such that wind blows in a radial direction. The second opening region is integrally formed with the fan guard or is provided on a side of a separate member. The blower fan is of a centrifugal type, and an outer edge position of the first opening region is positioned further outward than an outer edge position of the suction opening in the radial direction when viewed in a direction perpendicular to the axial direction of the blower fan. The multiple first air holes in the first opening region are arranged such that the positions thereof in the axial direction deviate in a gradual or stepwise manner toward an axial line of the blower fan from the side of the outer edge. At this time, the first air holes in an inner circumferential portion close to the axial line are arranged to be closer to the blower fan than the first air holes in an outer circumferential portion away from the axial line. A shape of the first air holes is an oval that extends in a long length in the radial direction, the first air holes are obliquely arranged such that positions on the inner circumferential side and the outer circumferential side of the oval in the axial direction differ from each other, and an average aperture ratio in the inner circumferential portion in the first opening region is set to be larger than an average aperture ratio in the outer circumferential portion. In addition, a total area of the first air holes which is present in the first opening region is smaller than an area of the suction opening. Also, the concave portion is formed into a cone shape that has a smooth inclination.

According to yet another feature of the present invention, there is provided a portable blower including: a drive source that causes a blower fan to rotate; a housing that accommodates the drive source and includes a handle portion formed at an upper portion thereof; a volute chamber that is provided in the housing and accommodates the blower fan; a suction opening that is provided in a wall surface of the volute chamber; and a fan guard that is attached to a side surface of the housing such that the fan guard is positioned outside the suction opening, in which a region that faces the suction opening in the fan guard is formed to be recessed from the outside toward the inside in a suctioning direction, multiple first air holes are arranged at positions that are different in the suctioning direction in the recessed region, and second air holes are arranged outside the recessed region. The recessed shape of the fan guard enables negative pressure generated by the blower fan to be dispersed. A first opening region that has the multiple first air holes formed in the recessed region in the fan guard is provided, and a second opening region that has multiple second air holes is arranged on an outer circumferential side of the first opening region.

### Advantageous Effects of Invention

According to the present invention, it is possible to reduce a negative pressure in a recessed space by a portion of external air and an atmospheric pressure being supplied into the recessed space (negative pressure relief space) from a second opening region on the outer circumferential side that is distant from the blower fan and is close to atmospheric pressure even in a case in which an operator or an obstructing object is present at the top of the concave portion of the fan guard and the concave portion is substantially tightly closed. Therefore, even in a case in which clothing clings to the blower, the operator can easily pull a blower main body apart from the clothing, and there is no adverse influence on operations since the negative pressure in the recessed space is maintained to be low and clinging force is small. In addition, since an aperture ratio is set to be larger toward the center of the concave portion that forms the recessed space, it is possible to maximize a negative pressure relief effect of the negative pressure relief space and to greatly reduce the negative pressure that reaches the top of the recessed space or the side of the operator. Further, since a larger aperture ratio is set in the second opening region than in the first opening region, it is easy to secure an amount of suctioning of the blower fan and to maintain an amount of wind.

### BRIEF DESCRIPTION OF DRAWINGS

FIG. 1 is a left side view of a blower 1 according to an embodiment of the present invention.

FIG. 2 is a sectional view taken along an A-A portion in the blower 1 according to the embodiment of the present invention.

FIG. 3 is a perspective view of the blower 1 according to the embodiment of the present invention and is a diagram illustrating a state in which a fan guard 40 is removed.

FIG. 4 is a perspective view illustrating a shape of a fan guard 40 alone in FIG. 1.

FIG. 5 is a diagram for describing a flow of air generated by a blower fan 20 (normal time).

FIG. 6 is a diagram for describing a flow of air generated by the blower fan 20 (in a case in which an obstructing object X is present in front of the fan guard 40).

FIG. 7 is a diagram for describing a size relationship between the fan guard 40 and a suction opening 30 in FIG. 1.

FIG. 8 is a vertical sectional view of a fan guard 140 according to a second embodiment of the present invention.

FIG. 9 is a vertical sectional view of a fan guard 240 according to the second embodiment of the present invention.

### DESCRIPTION OF EMBODIMENTS

### First Embodiment

Hereinafter, an embodiment of the present invention will be described. Note that the same reference numerals will be given to the same parts in the following drawings and repeated description thereof will be omitted. In addition, front-back, left-right, and up-down directions in the specification will be described as referring to directions when viewed from an operator gripping a blower in his/her right hand and will be assumed to represent directions illustrated in the drawings.

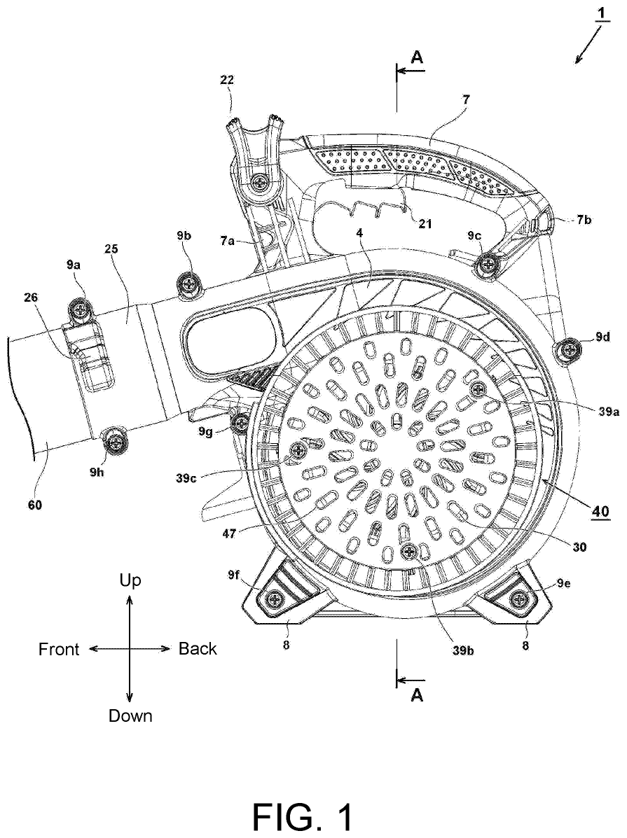

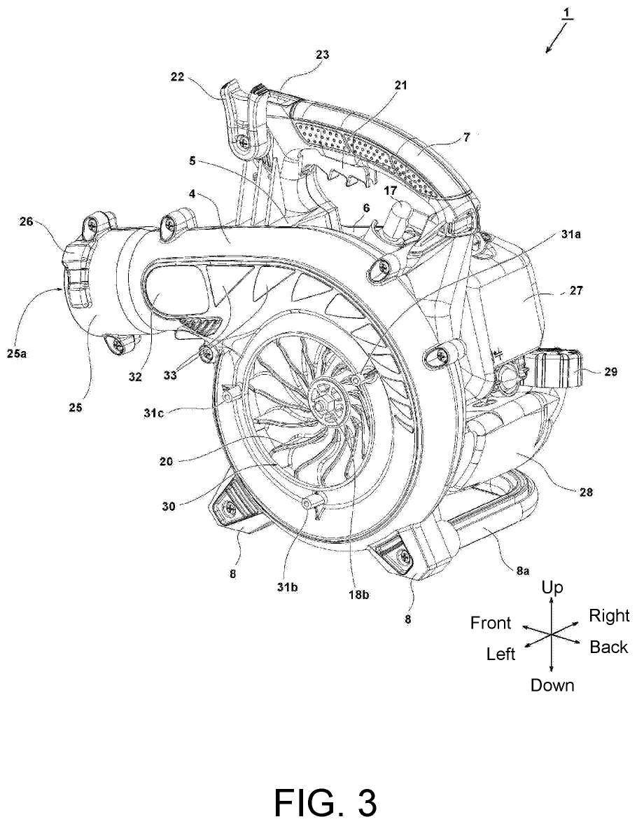

FIG. 1 is a left side view illustrating an entire blower 1 according to the embodiment of the present invention. The blower 1 is used to blow and gather fallen leaves, mown grass, and the like by causing a blower fan (which will be described later) to rotate by using an engine (which will be described later) accommodated in a housing as a drive source, suctioning external air, and causing wind generated by the blower fan to be discharged in a circumferential direction to the front side from a spiral-shaped volute chamber via a nozzle attachment portion 25 that serves as an ejection port. The housing that forms an outer wall of the blower 1 is formed by injection-molding a synthetic resin such as reinforced plastic into a mold. When the housing of the blower 1 is viewed from the left side, a suction opening 30 is provided at the center, and a guide path (volute chamber) for air ejected slightly downward on the front side to travel around the surroundings of the suction opening 30 in the counterclockwise direction is formed. Here, since only a part of an outer edge of the suction opening 30 is seen through the through-hole 47, details thereof will be described later with reference to FIG. 3. The housing of the blower 1 is formed into a shape in which the housing is divided in an axial direction of engine rotation. A handle portion 7 is formed above the housing. The handle portion 7 has a grip that is a part that has a substantially tubular shape extending in the front-back direction and that is gripped by the operator with his/her one hand, and a trigger-type throttle lever 21 is provided below the grip. The operator performs an operation while supporting the total weight of the blower 1 by gripping the handle portion 7 with one of his/her hands, adjusting a throttle output by operating the throttle lever 21 with his/her finger, and controlling the output of the engine. The throttle lever 21 is connected to a throttle wire (not illustrated) that operates a vaporizer (not illustrated) of the engine. A cruising lever 22 for maintaining a constant rotation frequency of the engine by holding the position of the throttle lever 21 is provided on an upper front side of the grip of the handle portion 7. Suspending holes 7a and 7b that are used to suspend the blower 1 are formed in side surfaces on the front side and the back side of the handle portion 7. A leg portion 8 for stably holding the blower 1 when the blower 1 is placed on a floor is provided below the housing.

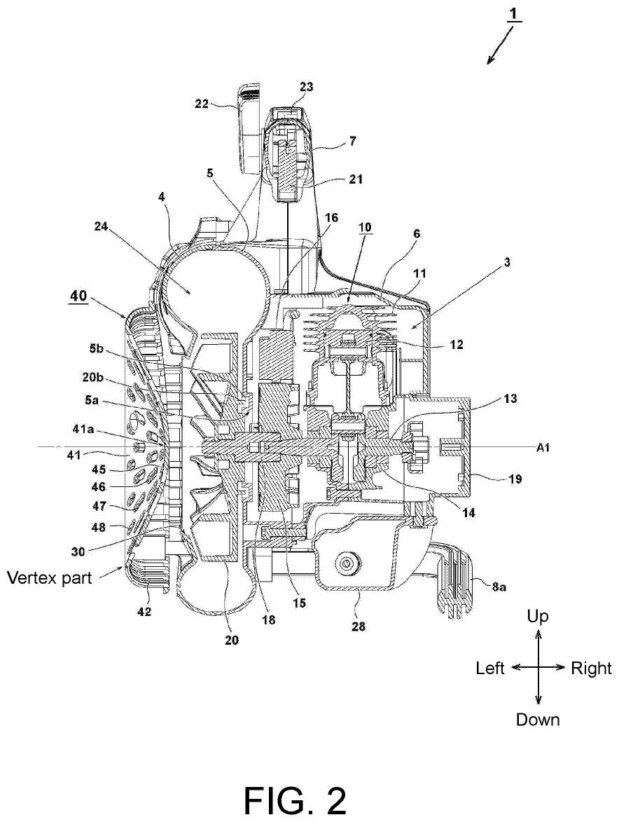

In the housing, a first case 4 is positioned on the left side surface illustrated in FIG. 1. The first case 4 forms the volute chamber that servers as a wind path along with a second case, which will be described later, and a circular fan guard 40 that covers the entire surface of the suction opening 30 is provided in the left side surface thereof. Multiple wind wholes (through-holes) are orderly arranged in the entire surface of the fan guard 40 such that air is allowed to flow into the suction opening 30 to inhibit suctioning of foreign matter into the suction opening 30 and prevent a part of the body, clothing, and the like of the operator from being suctioned. The fan guard 40 is secured to the first case 4 by using three screws 39a to 39c. In the vicinity of the outer edge of the first case 4, multiple screw bosses are formed, and the first case 4 and a second case 5 (which will be described later with reference to FIG. 2) are screwed together by using multiple screws 9a to 9h. The tubular nozzle attachment portion 25 is provided at an air exit of the volute chamber and can couple the coupling pipe 60, a conical jet tube, a fan-shaped nozzle, and the like, which are not illustrated in the drawing. For the connection to the coupling pipe 60 and the like, an attachment groove 26 that is raised into a substantially L shape in a side view is formed in the nozzle attachment portion 25. The attachment groove 26 engages with the coupling pipe 60 or a protrusion that is formed in an outer circumferential surface of the nozzle, which is not illustrated in the drawing. Note that as a method of securing the fan guard 40 to the first case 4, the fan guard 40 may be rotatably attached to the first case 4 with a hinge provided at a part. That is, guard means of the suction opening 30 can be opened and closed.

FIG. 2 is a sectional view taken along the A-A portion in FIG. 1. The housing of the blower 1 has an engine accommodating chamber 3 that accommodates the engine 10 on the right side from around the center when viewed in the left-right direction and has a volute chamber 24 that accommodates the blower fan 20 on the left side of the engine accommodating chamber 3 and forms a path for wind suctioned and discharged by the blower fan 20. The housing is formed by three separate cases that have bonded surfaces extending in the up-down and front-back directions, the volute chamber 24 is formed by the first case 4 and the second case 5, and the engine accommodating chamber 3 is formed by the second case 5 and a third case 6. That is, the second case 5 serves as a part of a case body of the volute chamber 24 and as a part of a case body of the engine accommodating chamber 3. The handle portion 7 is formed above the second case 5 and the third case 6. The left side surface of the handle portion 7 is integrally molded with the second case 5, and similarly, the right side surface of the handle portion 7 is integrally manufactured with the third case 6. The stop switch 23 for stopping the engine 10 by blocking an ignition circuit is provided on an upper front side of the handle portion 7. The leg portion 8 (see FIGS. 1 and 3) is provided below the first case 4 and the second case 5, and a support handle 8a that functions as a leg and also functions as a part that the operator grips when holding the blower 1 in a horizontally inclined posture is connected to the leg portion 8.

The engine 10 is a two-cycle small engine, a crankshaft 13 is arranged to horizontally extend in the right-left direction, and a piston 12 reciprocates in the up-down direction in a cylinder 11. The reciprocation of the piston 12 is transformed into rotating motion of the crankshaft 13. A fuel tank 28 is provided below the crank case 14. A mixed oil containing gasoline and oil mixed at a predetermined ratio is placed in the fuel tank 28. A manual activation device 19 is provided near the right end of the crankshaft 13. A known recoil starter can be used as the activation device 19, for example. A magneto rotor 15 is provided near the left end of the crankshaft 13. The magneto rotor 15 generates a flow of cooling wind in the engine accommodating chamber 3 in order to bring air into contact with a cooling fin formed outside the cylinder 11. An ignition coil 16 is provided on the outer circumferential side of the magneto rotor 15 such that the ignition coil 16 is adjacent to the magneto rotor 15 at a predetermined distance therefrom. The blower fan 20 is further attached to the left end of the crankshaft 13 via a connection member 18. With this configuration, both the magneto rotor (cooling fan) 15 connected to the crankshaft 13 and the blower fan 20 for generating operational wind rotate by the engine 10 being caused to run.

The space in which the blower fan 20 is accommodated, that is, the volute chamber 24 has a spiral-shaped space in an outer circumferential portion of the blower fan 20, and the suction opening 30 is provided on the left side (the side opposite to the engine 10) of the blower fan 20. The spiral-shaped space is a discharge path for guiding wind, which is blown toward the outside in the radial direction by the blower fan 20 of a centrifugal type, in one direction in the circumferential direction in accordance with the rotation direction, and wind that has reached the nozzle attachment portion 25 (see FIG. 1) is discharged from an ejection port 25a (which will be described later with reference to FIG. 3). The shape of the outer circumferential portion of the volute chamber 24 is formed such that a sectional shape that perpendicularly intersects a wind flowing direction is a substantially circular shape and the sectional area gradually enlarges in an upwind to a downwind direction. The magneto rotor 15 is accommodated inside the engine accommodating chamber 3, and the wall surface of the second case 5 partitions the magneto rotor 15 from the blower fan 20. The side of the engine of the blower fan 20 is formed into a so-called labyrinth structure by forming a tubular protrusion 20b and arranging the protrusion 20b close a concave portion 5b formed near the through-hole 5a of the second case 5, and air flow between the engine accommodating chamber 3 and the volute chamber 24 is blocked.

The fan guard 40 is provided on the left side of the first case 4 such that the fan guard 40 covers the entire suction opening 30. The fan guard 40 functions to form the left wall surface of the housing of the blower 1 and has a guard function of covering the suction opening 30, and further functions to cause air suctioned by the blower fan 20 to pass therethrough. The shape of the fan guard 40 is contrived such that all these plurality of functions are achieved. The fan guard 40 is formed by integral molding of a synthetic resin, and a wall surface 41 recessed inward into a cone shape when viewed from the outside is formed. Multiple through-holes (first air holes) 45 to 48 are concentrically formed in the wall surface 41. In addition, the outer circumferential side of the wall surface 41 with a cone shape is formed into a slit shape with a large opening. If the engine 10 is started and the crankshaft 13 rotates, the blower fan 20 rotates in synchronization with the rotation of the crankshaft 13. If the blower fan 20 rotates, air (external air) is suctioned from the suction opening 30 into the blower fan 20 and is then discharged to the outer circumferential side of the volute chamber 24 by the blower fan 20, and the discharged air moves in a predetermined direction along an outer circumferential wall of the volute chamber 24 and is then blown out to the side in front from the nozzle attachment portion 25 (see FIG. 1). At this time, the operator performs an operation while holding the handle portion 7 with his/her one hand and blowing the target with the blown air. At the time of stopping the engine 10, supply of a high-voltage current to an ignition plug, which is not illustrated, is blocked by the operator switching the stop switch 23 from a running position to a stop position, and the engine 10 is then stopped.

FIG. 3 is a perspective view of the blower 1 according to the embodiment of the present invention and is a diagram illustrating a state in which screws 39a to 39b (see FIG. 1) are detached and the fan guard 40 (see FIG. 1) is removed. The suction opening 30 is formed on the left side of the first case 4, and screw bosses 31a to 31c for screwing the fan guards 40 are formed at three locations on the outer circumferential side of the suction opening 30. The screw bosses 31a to 31c are integrally manufactured with the first case 4 by molding of a synthetic resin. The blower fan 20 is arranged such that multiple fins are aligned in the circumferential direction, and these are manufactured by integral molding of a synthetic resin and are secured to the connection member 18 (see FIG. 2) with a nut 18b. A volute case that is formed by the first case 4 and the second case 5 is formed into a spiral shape such that wind flows in the counterclockwise direction when viewed from the left side surface of the blower 1, and an annular nozzle attachment portion 25 is formed slight downward toward the front side. Note that the substantially rectangular upraised portion 32 and multiple substantially triangular upraised portions 33 that is formed on the outer circumferential side of the suction opening 30 of the first case 4 are provided for design and in order to improve strength. A fuel cap 29 is provided at an opening of the fuel tank 28. A vaporizer and an air cleaner, which are not illustrated, are arranged above the fuel tank 28 and are covered with an air cleaner cover 27. A plug cap 17 connected to the ignition plug of the engine 10 is arranged slightly on the right side below the handle portion 7.

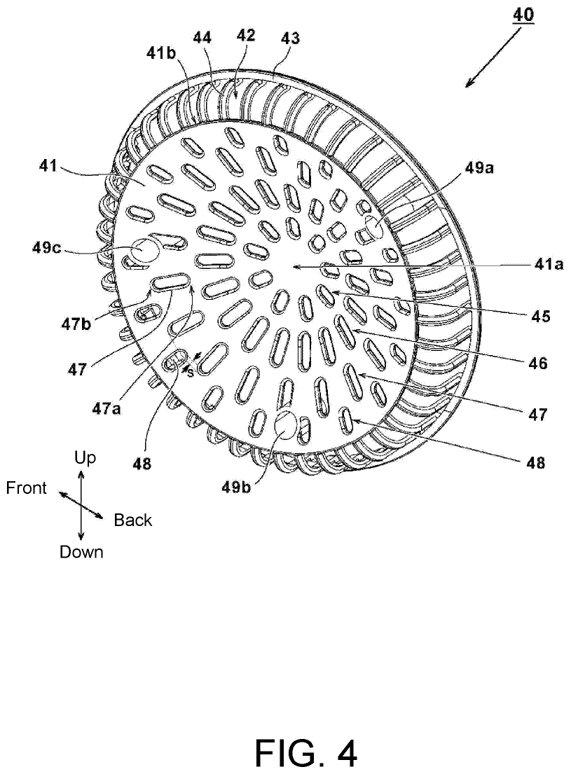

FIG. 4 is a perspective view illustrating a shape of the fan guard 40 alone and is a diagram when viewed from the front surface side (outside). The wall surface 41 in the form in which the wall surface 41 is recessed in a cone shape toward the suctioning side in the central axial line A1 direction is formed at the inner circumferential portion of the fan guard 40. Slit portions 42 (second air holes) with an increased aperture ratio are formed at a portion on the outer circumferential side of the fan guard 40. The wall surface 41 is formed into a cone shape such that the wall surface 41 is recessed toward the downstream side in the flowing direction such that the center 41a is coaxial with the central axial line A1 of the blower fan 20. Multiple oval through-holes 45 to 48 are arranged in the wall surface 41 from the center 41a toward the outside in the radial direction up to the position of the outer edge 41b of the wall surface 41. Multiple (nine) through-holes 45 are concentrically aligned and arranged in the circumferential direction on the innermost circumferential side, and through-holes 46 that are arranged concentrically aligned are arranged in the circumferential direction outside the through-holes 45. Further, eighteen through-holes 47 concentrically aligned and arranged in the circumferential direction are arranged outside the through-holes 46, and eighteen through-holes 48 concentrically aligned and arranged in the circumferential direction are arranged in the outermost periphery. These through-holes have oval shapes like the through-holes 47, for example, and are formed such that one side 47a thereof is positioned on the inner side while the other side 47b is positioned on the outer circumferential side. Here, a portion around the center 41a is a closed region with a wall formed therearound, and no holes are formed at a portion on the inner circumferential side of the through-holes 45, that is, around the center.

The through-holes 45 to 47 are arranged not to overlap with each other in the radial direction along the wall surface 41, and the through-holes 47 and 48 slightly overlap with each other by a distance S in the radial direction along the wall surface 41. Note that since a purpose of arranging the through-holes 45 to 48 within the region of the wall surface 41 is to adjust a distribution of a negative pressure outside the wall surface 41 by restricting the amount of wind to be blown into the suction opening 30 through the wall surface 41 and suctioning an appropriate amount of wind, the through-holes 45 to 48 may be arbitrarily arranged as long as this purpose can be achieved. However, since it is essential to prevent large pieces of foreign matter from entering the suction opening 30, it is preferable to provide small through-holes. The total area of the through-holes 45 to 48 in a portion (first region) of the wall surface 41 is set to be smaller than the area of the suction opening 30. It is possible to reliably push aside, to the outer circumferential side, the negative pressure caused by the blower fan 20 outside the wall surface that forms the concave portion and to reduce the negative pressure acting on the side of the operator by employing this area ratio. Note that the total area of the through-holes 45 to 48 in the first region is 32% of the suction opening in the embodiment. According to verification performed by the inventors, the total area is preferably within a range of 10% to 50% and is particularly preferably around 30%. Since a distribution of the negative pressure caused by the blower fan 20 increases in an exponential manner toward the central axial line A1, it is desirable to set a closed region where no large through-holes are formed near the center of the concave portion of the wall surface 41, and this makes it possible to effectively disperse the negative pressure.

A portion outside the wall surface 41 (second opening region), that is, the slit portion 42 is formed to have a sufficiently large aperture ratio such that it is possible to suction a large amount of air and suctions air to supplement the insufficient air flowing through the through-holes 45 to 48. Here, multiple coupling frames 44 extending in a radial direction connect between the circular outer edge 41b of the wall surface 41 and the outer frame 43 in the slit portion 42. Intervals between the coupling frames 44 is narrow intervals to prevent large foreign matters from entering the inside. Since the fan guard 40 is secured to the first case 4 (see FIG. 1) with three screws 39a to 39c (see FIG. 1), screw holes 49a to 49c are provided in the region in the wall surface 41.

As described above, the wall surface 41 is formed into a convex shape toward the downwind side to form the portion (first opening region) of the wall surface 41 of the fan guard 40, and the portion outside the slit portion 42 (second opening region) is formed to have a large aperture ratio. In addition, it is possible to appropriately distribute the negative pressure caused by the blower fan 20 by arranging the plurality of through-holes (wind holes) that form the first openings (a total area of the openings) in the first opening region such that positions thereof in the axial direction gradually deviate from the side of the outer edge toward the axial line of the blower fan and arranging the through-holes in the inner circumferential portion near the axial line A1 to be close to the side of the blower fan 20 than the through-holes in the outer circumferential portion away from the axial line A1.

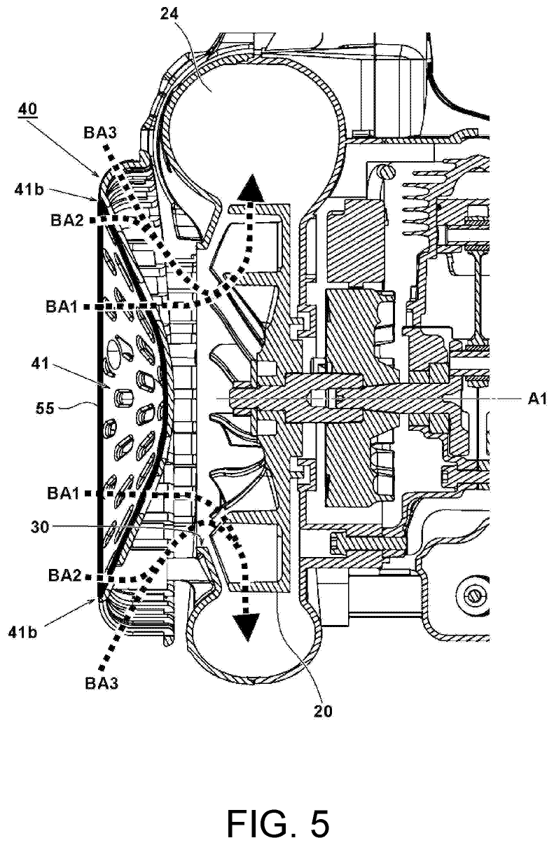

FIG. 5 is a diagram for describing a flow of air generated by the blower fan 20 (normal time). The blower fan 20 is a so-called centrifugal fan, suctions air in the axial direction in a region on the central side near the central axial line A1 of the blower fan 20, and discharges the air toward the outside in the radial direction. Here, the surface (wall surface 41), which faces the suction opening 30, of the fan guard 40 is recessed from the outside toward the inside, thereby forming a cone shaped space (here, referred to as a “negative pressure relief space 55”) that has a smooth inclination as surrounded by the thick line. That is, the suctioned wind is caused to flow through the first opening region as represented by BA1 and BA2 by forming the wall surface 41 into a convex shape at a portion, which faces the blower fan 20, of the fan guard 40 toward the blower fan 20 and arranging the plurality of through-holes 45 to 48 (see FIG. 4) inside the convex portion (first opening region). In addition, since the second opening region with large openings capable of suctioning a large amount of air is formed outside the negative pressure relief space 55, it is possible to further supplement the insufficient wind supplied from BA1 and BA2 by causing the wind to flow as represented by BA3. In this manner, since the negative pressure relief space 55 is provided in the embodiment, it is possible to push aside the negative pressure, which is caused from the center position of the blower fan 20 toward the fan guard 40, toward the outer circumferential side by the concave-shaped negative pressure relief space 55 and to cause the space to act to reduce the negative pressure generated on the side of the operator. In addition, since the through-holes 45 to 48 formed in the negative pressure relief space 55 enables suctioning of a linear air flow from the inside of the region of the wall surface 41 (first opening region) to the blower fan 20, the amount of wind for the blower fan 20 is easily secured.

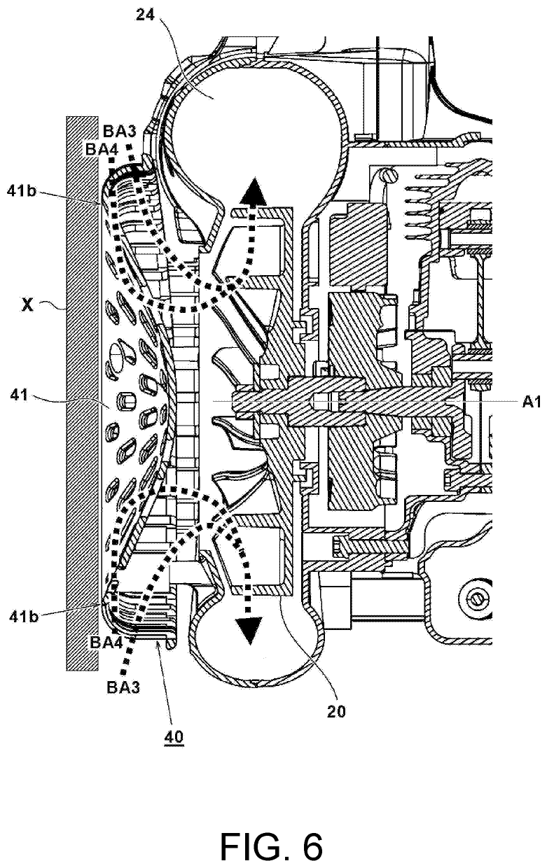

FIG. 6 is a diagram for describing wind flows BA3 and BA4 generated by the blower fan 20 in a case in which an obstructing object X is present in front of the fan guard 40. The blower 1 is adapted such that the operator performs an operation while operating the handle portion 7 in a state in which the operator holds the handle portion 7 with his/her one hand or suspending the blower 1 from shoulders with a belt via suspending holes 7a and 7b, and most of persons perform the operation in a state in which the blower 1 is positioned on the right side of the operators since the operators operate the throttle lever 21 with their right hand. At this time, there is a concern that obstructing object X such as clothing is suctioned by the wind BA1 and BA2 (see FIG. 5) suctioned if the obstructing object X is brought into contact with the fan guard 40 since the obstructing object X such as the body, the clothing, or the like of each operator is adjacent to the left side of the fan guard 40. Then, the air flows as represented by BA1 and BA2 are blocked and are thus shifted to the wind flows BA3 and BA4 as illustrated in FIG. 6. As for the air flow after the shifting, a wind flow suctioning from the region (second opening region) on the outer circumferential side of the wall surface 41 as represented by BA3 is similar to that in the example illustrated in FIG. 5 while flow that is suctioned from the second opening region, once flows into the negative pressure relief space 55 (see FIG. 5) via the through-holes 48, and is then suctioned into the blower fan 20 via the through-holes 47 or the through-holes 45 and 46 inside the through-holes 47 as represented by BA4 occurs. Even in a case in which the operator or the obstructing object X is present at the top of the fan guard 40 and the first opening region is tightly closed, it is possible to smoothly guide the air flow directed to the suction opening 30, to reduce the negative pressure in the negative pressure relief space 55, and to enhance blowing efficiency and the amount of wind by a part of external air being supplied from the through-holes 48 on the outer circumferential side that is away from the central axial line A1 of the blower fan 20 and is close to atmospheric pressure to the negative pressure relief space 55, according to the embodiment. Therefore, it is possible to reduce the negative pressure and clinging force outside the first opening region in the axial direction without causing the negative pressure to concentrate on the second opening region and causing the clothing and the like to strongly cling the outer periphery, by releasing a minute negative pressure to the side of the operator even inside the first opening region. Further, since it is possible to uniformly reduce the negative pressure of the openings in the first opening region and the second opening region (that is, all the openings) formed in the guard, the negative pressure in the negative pressure relief space 55 is maintained to be low, the clinging force becomes small, and it is possible for the operator to easily push aside the main body of the blower 1 from the clothing even in a case in which the clothing of the operator clings.

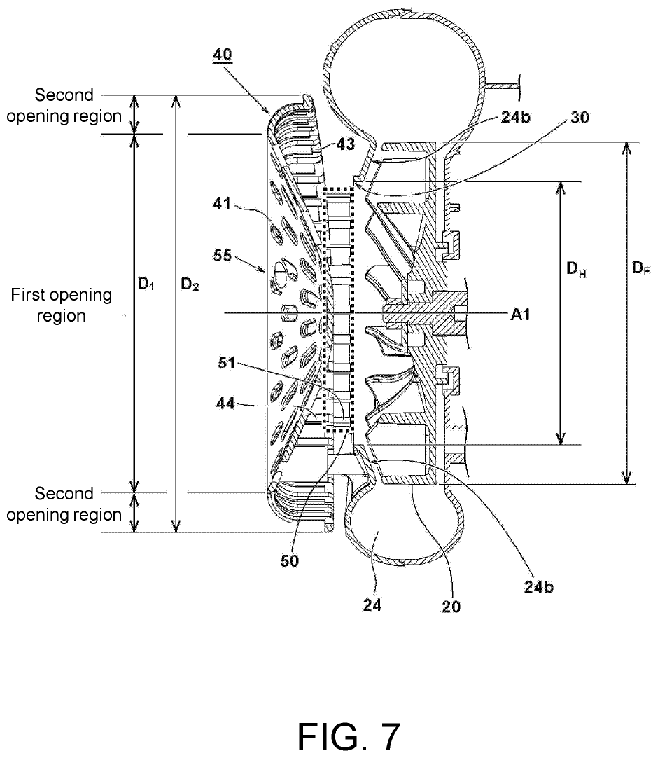

FIG. 7 is a diagram for describing a size relationship between the fan guard 40 and the suction opening 30. The blower fan 20 with a diameter D_{F} is arranged inside the volute chamber 24, and the suction opening 30 is formed in the wall surface 24b on the left side of the blower fan 20. The suction opening 30 is a circular opening arranged coaxially with the central axial line A1, and the diameter D_{H} is formed to be smaller than a diameter D_{F} of the blower fan 20. A concave portion (negative pressure relief space 55) that is recessed from the outside toward the side of the suction opening 30 and is arranged concentrically with the axial direction of the blower fan 20 is formed in the fan guard 40. A diameter D₁ of the first opening region is formed to be larger than the diameter D_{F} of the blower fan 20. That is, the position of the outer edge of the first opening region when viewed in a direction perpendicular to the axial direction A1 of the blower fan 20 is located further outward than the position of the outer edge of the suction opening 30 in the radial direction. An outer diameter D₂ of the second opening region is formed to be larger than the diameter D₁ of the first opening region. Note that as is obvious from FIG. 7, a grid-shaped extending guard portion 50 is formed at a portion surrounded by the dotted line at a part of the fan guard 40. The extending guard portion 50 is formed such that multiple frameworks 51 extend on the side of the first case 4. A portion around which the extending guard portion 50 is arranged is a portion near a front portion in which an inner diameter of the volute chamber 24 with a spiral shape and with a gradually increasing inner diameter is small. That is, the extending guard portion 50 is provided to avoid entrance of foreign matters since the distance between the volute chamber 24 and the outer frame 43 increases. Note that although a predetermined gap is provided between the outer frame 43 and the first case 4 even at a portion in the circumferential direction other than the portion at which the extending guard portion 50 is formed, external air is suctioned via such a gap.

As described above, since the total area of the openings in the first opening region (first openings) is set to be smaller than the total area of the openings in the second opening region (second openings) in the embodiment, it is possible to push aside the negative pressure, which is caused from the center of the blower fan toward the guard, toward the outer circumferential side by the concave-shaped negative pressure relief space 55 and to reduce the negative pressure caused on the side of the operator. Further, it is also possible to reduce the negative pressure in the second opening region and the clinging force without the negative pressure concentrating on the second openings and the clothing and the like strongly clinging to the outer periphery, by releasing a minute negative pressure to the side of the operator through the first openings.

Therefore, it is possible to uniformly reduce the negative pressure in the first openings and the second openings (that is, all the openings) formed in the guard and to greatly reduce the negative pressure and the clinging force in the surroundings of the guard while securing the amount of wind. Note that although the second opening region is integrally formed by the fan guard 40 in the embodiment, the second opening region portion may be formed by a member separated from the first opening region.

### Second Embodiment

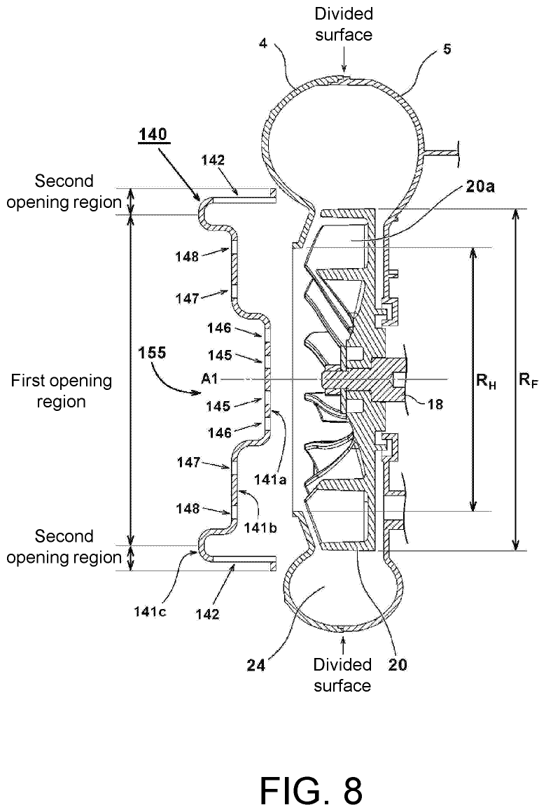

FIG. 8 is a vertical sectional view of a fan guard 140 according to a second embodiment of the present invention. Only the fan guard 40 in the first embodiment is replaced with a fan guard 140 in the second embodiment, and the other configurations are the same as the configurations in the first embodiment. The fan guard 40 according to the first embodiment permits a wind flow in the radial direction as represented by BA4 in FIG. 6 via the through-holes 48 by arranging the through-holes 45 to 48 in the oblique surface in the form in which the first opening region is recessed into the cone shape when viewed from the outside. The concave portion with the cone shape is replaced with a concave portion that is recessed into a two-stage stepped shape in the second embodiment, and multiple through-holes are arranged in each of the stepped surfaces (141a, 141b). In the fan guard 140, the central portion of the first opening region is formed into a circular central surface 141a that is the closest to the blower fan 20, the outermost periphery is formed into an annular circumferential surface 141c, and an annular intermediate circumferential surface 141b with a step in the axial direction is formed between the central surface 141a and the outer circumferential surface 141c. Multiple through-holes 145 are concentrically arranged on the inner side, and multiple through-holes 146 are concentrically arranged on the outer side thereof in the central surface 141a. Multiple through-holes 147 are concentrically arranged on the inner side, and multiple through-holes 148 are concentrically arranged on the outer side thereof in the intermediate circumferential surface 141b. Although the outer circumferential surface 141c at the top (the furthest location when viewed in the axial direction of the central axial line A1 from the blower fan 20) of the fan guard 140 is formed into an annular surface with a predetermined length in the radial direction, no through-holes are formed here. A portion inside the center of the outer circumferential surface 141c in the radial direction corresponds to the first opening region, while the outer portion corresponds to the second opening region. In the second opening region, multiple frameworks extending in parallel to the axial direction are formed, and multiple large openings 142 are formed between the frameworks.

The shapes of the through-holes 145 to 148 formed in the central surface 141a and the intermediate circumferential surface 141b are any of circular shapes or oval shapes that radially extend from the center. Here, the through-holes are formed such that an aperture ratio AR₁ in the first opening region (the proportion of the area of the holes per area) is smaller than an aperture ratio AR₂ in the second opening region. Further, an aperture ratio AR_{1A} in the central surface 141a is smaller than an aperture ratio AR_{1B} in the intermediate circumferential surface 141b in the first opening region. In this manner, it is possible to reliably push aside the negative pressure caused by the blower fan 20 toward the outer circumferential side by the concave portion and to reduce the negative pressure acting on the side of the operator by forming the plurality of through-holes in the first opening region such that the positions thereof in the axial direction deviates in a stepwise manner from the side of the outer edge toward the axial line A1 and setting the aperture ratio on the inner side to be smaller than that in the outer portion in the negative pressure relief space 155 recessed in the concave shape. In addition, since it is possible to smoothly guide the air flow directed form the first opening region or the second opening region to the suction opening, wind blowing efficiency and the amount of wind are easily enhanced.

### Third Embodiment

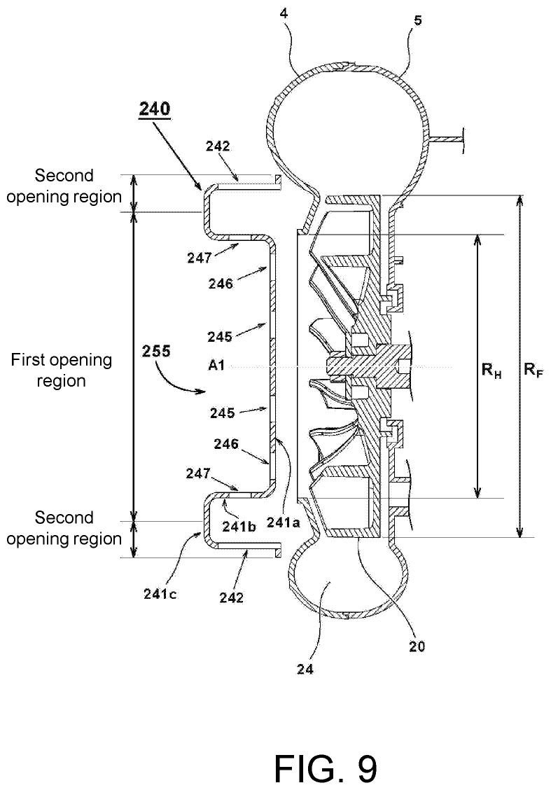

FIG. 9 is a vertical sectional view of a fan guard 240 according to a third embodiment of the present invention. In the second embodiment, the central surface 141a and the intermediate circumferential surface 141b of the fan guard 140 in the second embodiment are formed in the same recessed surface 241a, and multiple through-holes 245 to 246 are formed in the recessed surface 241a. An inner portion of the outer circumferential surface 241c in the radial direction corresponds to the first opening region while an outer portion corresponds to the second opening region. Through-holes 247 are further formed in a side wall portion recessed into the concave shape, that is, an inner circumferential wall 241b. The fan guard 240 is adapted such that the recessed surface 241a is arranged at an equal distance from the blower fan 20 and no through-holes are formed near the center that intersects the central axial line A1. The plurality of through-holes 245 are concentrically arranged on the outer side near the center, and the plurality of through-holes 246 are concentrically arranged outside the through-holes 245. Openings of the through-holes 247 are arranged to have openings that are parallel to the central axial line A1. Although an outer circumferential surface 241c at the top (the furthest location when viewed in the axial direction of the central axial line A1 from the blower fan 20) of the fan guard 240 is formed into an annular surface that has a predetermined width in the radial direction, no through-holes are formed here. In the second opening region, multiple frameworks that extend in parallel to the axial direction are formed, and multiple large openings 242 are formed between the frameworks.

The third embodiment is also formed such that an aperture ratio AR₁ (the proportion of the area of the holes per surface area) in the first opening region is smaller than an aperture ratio AR₂ in the second opening region. Also, an aperture ratio AR_{1A} in the recessed surface 241a is larger than an aperture ratio AR_{1B} in the inner circumferential wall 241b in the first opening region. Since the aperture ratio on the inner side is smaller than that in the outer portion in the negative pressure relief space recessed into the concave shape with this formation, it is possible to reliably push aside the negative pressure caused by the blower fan 20 to the outer circumferential side by the concave portion and to reduce the negative pressure acting on the side of the operator. In addition, even in a case in which the first opening region is tightly closed by the operator or the obstructing object X, a part of external air is supplied from the opening 242 on the outer circumferential side into the negative pressure relief space via the through-holes 247 and the flows to the side of the blower fan 20 via the through-holes 245 and 246, and the negative pressure in the negative pressure relief space 255 can thus be reduced.

Although the present invention has been described above on the basis of the plurality of embodiments, the present invention is not limited to the aforementioned embodiments, and various modifications can be made without departing from the gist thereof. For example, although the blower that uses the engine as the drive source has been described in the aforementioned embodiments, the blower may use another power source such as an electric motor. Further, although the present invention has been applied to the fan guard that is used in the suction opening of the blower fan in the blower, the present invention is not limited to the blower and may be applied to a guard that covers a suction opening into which air is suctioned by a fan.

### REFERENCE SIGNS LIST

1 Blower

3 Engine accommodating chamber

4 First case

5 Second case

5a Through-hole

5b Concave portion

6 Third case

7 Handle portion

7a, 7b Suspending hole

8 Leg portion

8a Support handle

9a to 9h Screw

10 Engine

11 Cylinder

12 Piston

13 Crankshaft

14 Crank case

15 Magneto rotor

16 Ignition coil

17 Plug cap

18 Connection member

18b Nut

19 Activation device

20 Blower fan

20a Fin

20b Protrusion

21 Throttle lever

22 Cruising lever

23 Stop switch

24 Volute chamber

24b Wall surface

25 Nozzle attachment portion

25a Ejection port

26 Attachment groove

27 Air cleaner cover

28 Fuel tank

29 Fuel cap

30 Suction opening

31a to 31c Screw boss

32, 33 Upraised portion

39a to 39c Screw

40 Fan guard

41 Wall surface (first opening region)

41a Center

41b Outer edge

42 Slit portion (second air holes, second opening region)

43 Outer frame

44 Coupling frame

45 to 48 Through-hole (first air holes)

49a to 49c Screw hole

50 Extending guard portion

51 Framework

55 Negative pressure relief space

60 Coupling pipe

140 Fan guard

141a Central surface

141b Intermediate circumferential surface

141c Outer circumferential surface

142 Opening

145, 146 Through-hole

240 Fan guard

241a Recessed surface

241b Inner circumferential wall

241c Outer circumferential surface

242 Opening

245 to 247 Through-hole

255 Negative pressure relief space

A1 Central axial line

BA1 to BA4 Wind flow

X Obstructing object

1. A blower, being portable, comprising:
a drive source that causes a blower fan to rotate;
a housing that accommodates the drive source and includes a handle portion formed thereon;
a volute chamber that accommodates the blower fan;
a suction opening that is formed in a wall surface of the volute chamber; and
a fan guard that is attached to the outside of the suction opening in the manner of facing the operator on an operation,
wherein a concave portion that is recessed from the outside toward the side of the suction opening and is arranged substantially concentrically with an axial direction of the blower fan is formed in the fan guard,
multiple first air holes are formed inside the concave portion, and
multiple second air holes are formed outside the concave portion.

2. The blower according to claim 1,
wherein a total area of the multiple first air holes in a first opening region that is formed inside the concave portion of the fan guard is smaller than a total area of the multiple second air holes in a second opening region that is formed outside the concave portion.

3. The blower according to claim 2,
wherein the multiple first air holes in the first opening region are formed to include openings that are obliquely formed relative to the axial direction such that wind blows in a radial direction.

4. The blower according to claim 2,
wherein the second opening region is integrally formed with the fan guard or is provided on a side of a separate member.

5. The blower according to claim 4,
wherein the blower fan is of a centrifugal type, and an outer edge position of the first opening region is positioned further outward than an outer edge position of the suction opening in the radial direction when viewed in a direction perpendicular to the axial direction of the blower fan.

6. The blower according to claim 5,
wherein the multiple first air holes in the first opening region are arranged such that the positions thereof in the axial direction deviate in a gradual or stepwise manner toward an axial line of the blower fan from the side of the outer edge, and the multiple first air holes in an inner circumferential portion close to the axial line are arranged to be closer to the blower fan than the multiple first air holes in an outer circumferential portion away from the axial line.

7. The blower according to claim 6,
wherein a shape of the multiple first air holes is an oval that extends in a long length in the radial direction, and the multiple first air holes are obliquely arranged such that positions on the inner circumferential side and the outer circumferential side of the oval in the axial direction differ from each other.

8. The blower according to claim 6, wherein an average aperture ratio in the inner circumferential portion in the first opening region is set to be larger than an average aperture ratio in the outer circumferential portion.

9. The blower according to claim 6,
wherein a total area of the multiple first air holes in the first opening region is smaller than an area of the suction opening.

10. The blower according to claim 2,
wherein the concave portion is formed into a cone shape that has a smooth inclination.

11. A blower, being portable, comprising:
a drive source that causes a blower fan to rotate;
a housing that accommodates the drive source and includes a handle portion formed at an upper portion thereof;
a volute chamber that is provided in the housing and accommodates the blower fan;
a suction opening that is provided in a wall surface of the volute chamber; and
a fan guard that is attached to a side surface of the housing and disposed outside the suction opening in the manner of facing the operator on an operation,
wherein a recessed region that faces the suction opening in the fan guard is formed to be recessed from the outside toward the inside in a suctioning direction,
multiple first air holes are arranged at positions that are different in the suctioning direction in the recessed region, and multiple second air holes are arranged outside the recessed region.

12. The blower according to claim 11,
wherein a first opening region hat has the multiple first air holes formed in the recessed region in the fan guard is provided, and
a second opening region that has the multiple second air holes is arranged on an outer circumferential side of the first opening region.

13. The blower according to claim 7,
wherein an average aperture ratio in the inner circumferential portion in the first opening region is set to be larger than an average aperture ratio in the outer circumferential portion.
